(19) United States
(12) Patent Application Publication
(10) Pub. No.: US 2021/0270521 A1
(43) Pub. Date: Sep. 2, 2021

(54) CONTROLLED THAWING CABINET

(71) Applicant: CARTER-HOFFMANN LLC, Mundelein, IL (US)

(72) Inventors: Michael C. Crutcher, Lake Villa, IL (US); Gary A. Russell, McHenry, IL (US); Richard J. Paddock, JR., Antioch, IL (US); David Abi Abdallah, Pembroke Pines, FL (US)

(21) Appl. No.: 17/187,959

(22) Filed: Mar. 1, 2021

Related U.S. Application Data
(60) Provisional application No. 62/983,979, filed on Mar. 2, 2020.

(51) Int. Cl. F25D 31/00; F25D 17/06; F25D 29/00

(52) U.S. Cl. CPC F25D 31/005; F25D 17/06; F25D 2700/121; F25D 2300/00; F25D 2600/06; F25D 29/003

(57) ABSTRACT

An enclosed unit for thawing a food product is provided. The unit includes a food storage compartment and auxiliary compartment. The auxiliary compartment receives air flow from the food storage compartment and directs air across an evaporator and a heating element. A controller controls operation of the evaporator and the heating element to control the temperature around one of several nominal temperature levels associated with a recipe to thaw frozen food items disposed within the food storage compartment in a controlled manner, which is faster than placing the food within an initially refrigerated compartment for thawing.

### CROSS-REFERENCE TO RELATED APPLICATIONS

This application claims priority from U.S. Provisional Application No. 62/983,979 filed on Mar. 2, 2020, the entirety of which is hereby fully incorporated by reference herein.

### BACKGROUND

The subject disclosure relates to cabinets that can refrigerate and can allow for thawing of food products therein in a controlled environment, with a faster rate of thawing than simply placing the frozen food product(s) into a refrigerated environment yet minimizing the risk of spoliation.

### BRIEF SUMMARY

A first representative embodiment of the disclosure is provided. The embodiment includes an enclosed unit for thawing a food product. The enclosed unit includes a housing defining a food storage compartment and an auxiliary compartment, the food storage compartment defined by a plurality of walls including top and bottom walls, right and left walls, and a back wall, the food storage compartment has a front opening, which can be selectively enclosed or opened with at least one door. The housing encloses a refrigeration system with an evaporator disposed within an auxiliary compartment, the auxiliary compartment further comprising a plurality of heaters. An air flow path is provided between the food storage compartment and the auxiliary compartment, a fan disposed within a suction aperture within one of the plurality of walls, wherein the fan takes suction from the food storage compartment and exhausts air into the auxiliary compartment where air passes across the evaporator and across one or more of the plurality of heaters, one or more of the plurality of walls includes a plurality of return apertures through which air flows after passing across the evaporator and across one or more of the plurality of heaters. The unit further includes a controller and a temperature sensor. The temperature sensor is disposed to measure the temperature of air within the housing, the controller receiving the measured temperature from the temperature sensor and comparing the measured temperature to a desired nominal air temperature established within a recipe. When the measured air temperature is below the desired air temperature by at least a first predetermined threshold, the controller energizes the plurality of heaters and deenergizes the refrigeration system if it was currently operating, and when the measured temperature is above the desired air temperature by at least a second predetermined threshold the controller energizes the refrigeration system and deenergizes the plurality of heaters if they were currently operating.

Advantages of the present disclosure will become more apparent to those skilled in the art from the following description of the preferred embodiments of the disclosure that have been shown and described by way of illustration. As will be realized, the disclosed subject matter is capable of other and different embodiments, and its details are capable of modification in various respects. Accordingly, the drawings and description are to be regarded as illustrative in nature and not as restrictive.

### BRIEF DESCRIPTION OF THE DRAWINGS

FIG. 1 is perspective view of an enclosed thawing cabinet with the door of the cabinet shut.

FIG. 2 is another perspective view of the enclosed thawing cabinet of FIG. 1 with the door removed.

FIG. 3 is a front view of the enclosed thawing cabinet of FIG. 2.

FIG. 4 is a front cross-sectional view of the enclosed thawing cabinet of FIG. 2.

FIG. 5 is a perspective cross-sectional view of the view of FIG. 4.

FIG. 6 is a top perspective view of a portion of the auxiliary compartment of the cabinet of FIG. 1 schematically depicting flow past the evaporator.

FIG. 7 is another top perspective view of a portion of the auxiliary compartment of the cabinet of FIG. 1 schematically depicting air flow past the evaporator and past the heater.

FIG. 8 is a left side view of the enclosed thawing cabinet with the left side outer wall removed to depict the left plenum and schematically depicting air flowing past the heater.

### DETAILED DESCRIPTION OF THE PREFERRED EMBODIMENTS

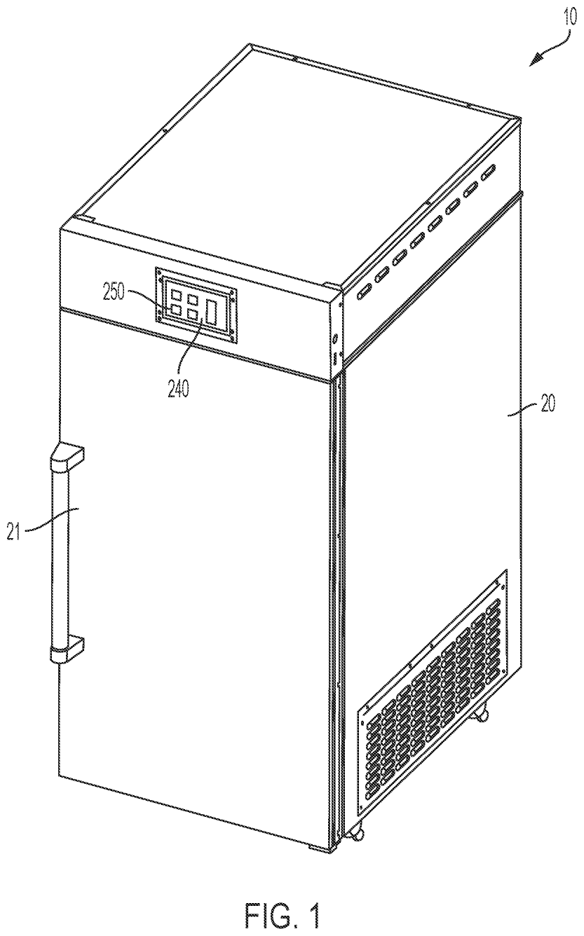

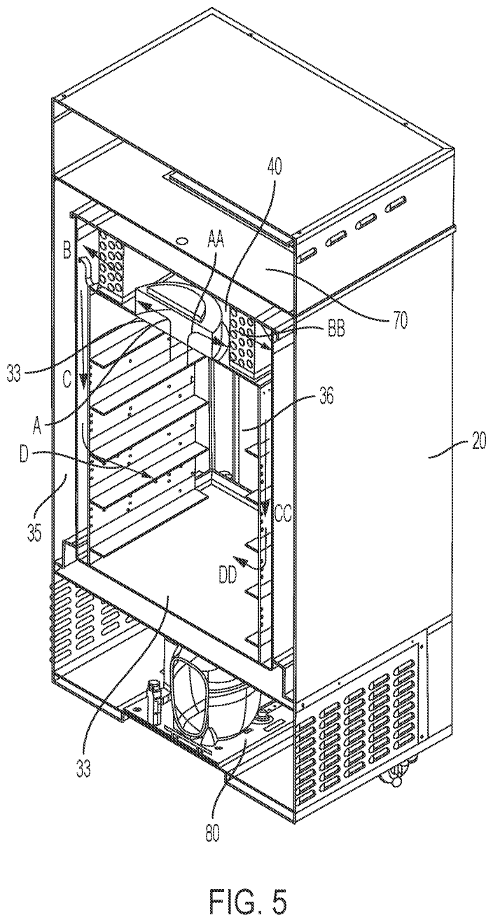

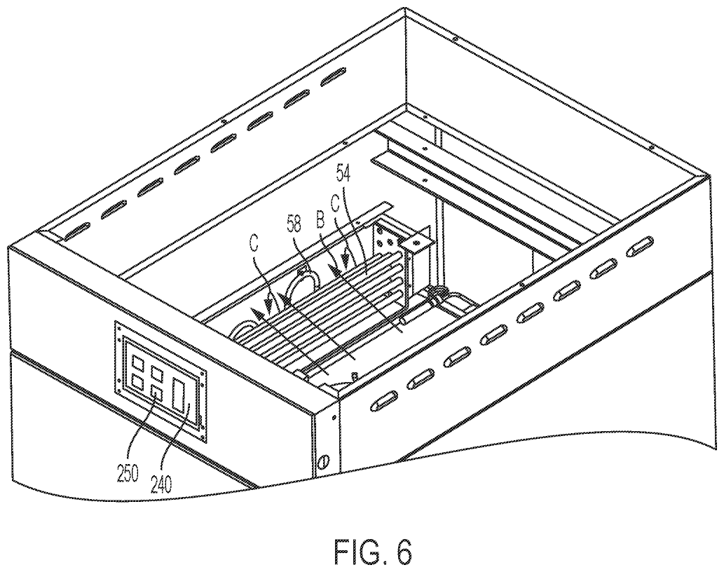

Turning now to FIGS. 1-8 an enclosed thawing cabinet 10 is provided. The cabinet 10 may be an enclosed cabinet with a food storage compartment 30 and one or more auxiliary compartments 60, 70, 80 that enclose the electrical and mechanical components to operate and maintain a thawing and in some embodiments longer term refrigerated environment for a food product disposed within the food storage compartment 30. The cabinet 10 may be of various sizes, such as under counter, half size, or full size and the operation of the cabinet based upon the varying sizes will be the same. In some embodiments, the cabinet 10 may include two or more different food storage compartments 30 that are operated in different modes or at different internal temperatures to allow for different food products to be included (and at differing steps within a thawing process).

The food storage compartment 30 may be an enclosed environment, which is normally enclosed by a door 21, which can be opened to allow for access into the enclosed environment to insert or to remove foods from the enclosed environment. The term “food” is used herein generally and can cover food (human or animal) or liquids, or items which are not intended for human or animal consumption, which are desired to be thawed from a frozen state to a refrigerated state (i.e. below room temperature).

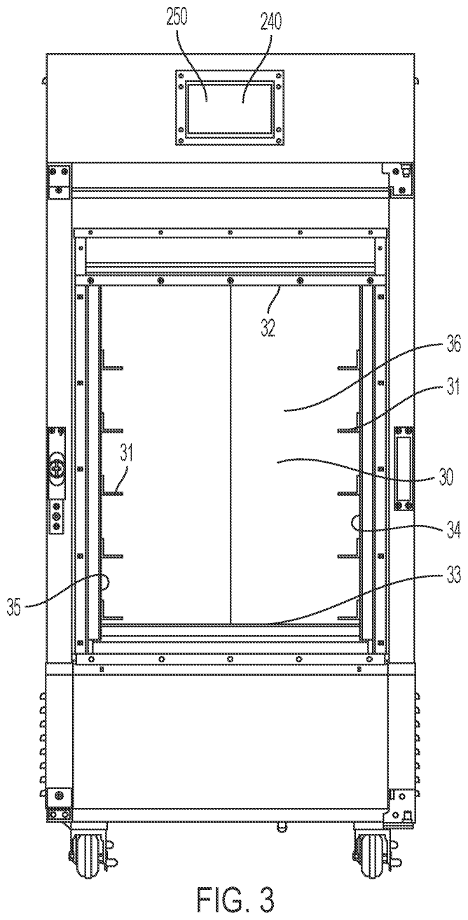

The food storage compartment 30 may include left and right side walls 34, 35 (from the perspective of the view of FIG. 3), a top wall 32, a bottom wall 33, and a rear wall 36. In some embodiments, the left and right walls 34, 35 may include a plurality of shelves 31 that allow for racks or trays (not shown but conventional) to be disposed therein and to allow for repositioning the racks or trays to various different locations within the food storage compartment 30. The cabinet 10 may include outer walls that form a box-like unit, with insulation disposed between the outer walls and the walls that define the food storage compartment 30 to minimize the heat transfer between the environment and the enclosed environment. As discussed below, the cabinet 10 additionally includes a plurality of auxiliary compartments and a plurality of plenums, which enclose mechanical and electrical components that allow for operation of the cabinet as a device for thawing food within the enclosed environment in a controlled manner and to allow for long term refrigeration of the food storage compartment as desired, which are discussed in detail below.

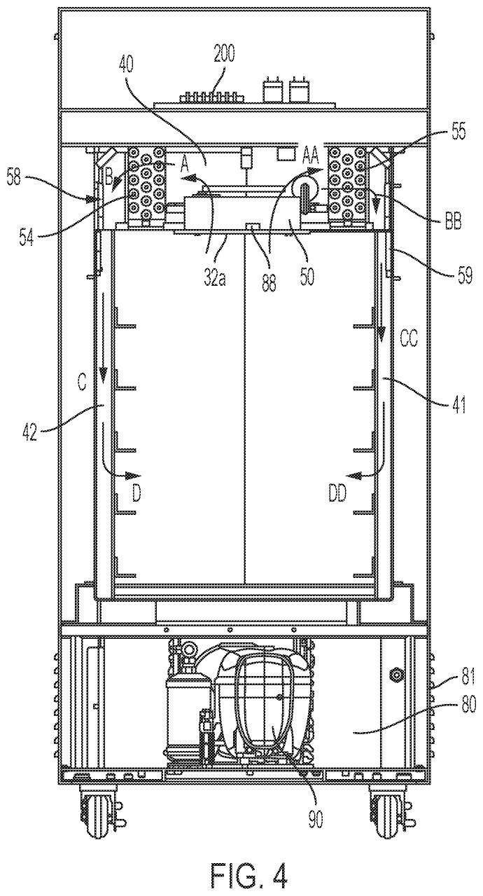

The cabinet 10 includes a heat transfer compartment 40, which is an auxiliary compartment, which urges air circulation to and from the food storage compartment 30, and which also selectively provides cooling or heating to the air flowing through the heat transfer compartment 40. In some embodiments, the heat transfer compartment 40 includes a fan 50, which is disposed proximate to an aperture 32a in a wall that defines the food storage compartment 30, such as the top wall 32 as depicted in the figures. One of ordinary skill in the art after a thorough review of the subject specification and figures will readily understand that the aperture 32a (and therefore the fan 50 and other components of the cabinet) can be disposed in the back wall 36 and the remaining components rearranged to differing positions within the cabinet as driven by this change and the modification of the location of the remaining components would only result in routine modifications. The fan 50 is disposed to take suction from the food storage compartment 30 and discharge air into the heat transfer compartment 40, as depicted in flow paths A and AA in FIG. 4. In some embodiments, the fan urges air across the heat transfer compartment 40 at an angle substantially perpendicular to the direction that air is drawn into the suction of the fan 50.

The cabinet 10 further includes a refrigeration system 90, which may include components of a conventional refrigeration system 90, such as a condenser, and expansion valve, and an evaporator. In some embodiments, the evaporator is disposed within the heat transfer compartment 40 such that air from the fan 50 is urged past the evaporator to cool the air flowing therepast while the refrigeration system 90 is operating. In some embodiments, and as depicted in the figures, the evaporator may be a single evaporator (i.e. fluidly connected to a single condenser) but may include two sets of a tube or two sets of a plurality of tubes 54, 55 that are disposed upon opposite sides of the fan, such as left and right sides of the fan 50. In this embodiment, as shown schematically in FIG. 4, a first portion of the air flowing from the fan in a left direction B flows across the left tubes 54, and a second portion of the air flowing from the fan 50 in the right direction BB flows across the right tubes 55. As the air passes across the tubes 54, 55 during operation of the refrigeration system 90, the air transfers heat to the colder tubes, which therefor cools the air flowing in directions B and BB.

Respective left and right heaters 58, 59 may be disposed within the heat transfer compartment downstream of the left and right evaporator tubes 54, 55. Accordingly, when the heaters 58, 59 are operating, the heaters 58, 59 are at a higher temperature than the air flowing therepast (as shown schematically with arrows C and CC in FIG. 4) which increases the air temperature. In some embodiments, the left and right heaters 58, 59 may be directly downstream of the evaporator tubes 54, 55, while in other embodiments, the heaters may be disposed before the evaporator tubes. In still other embodiments, the heaters 58, 59 may be disposed at a distance from the evaporator tubes, such that the left and right heaters 58, 59 are disposed within the respective left and right plenums 58, 59, discussed below. The operation of the heaters and the refrigeration system 90 is discussed in greater detail below.

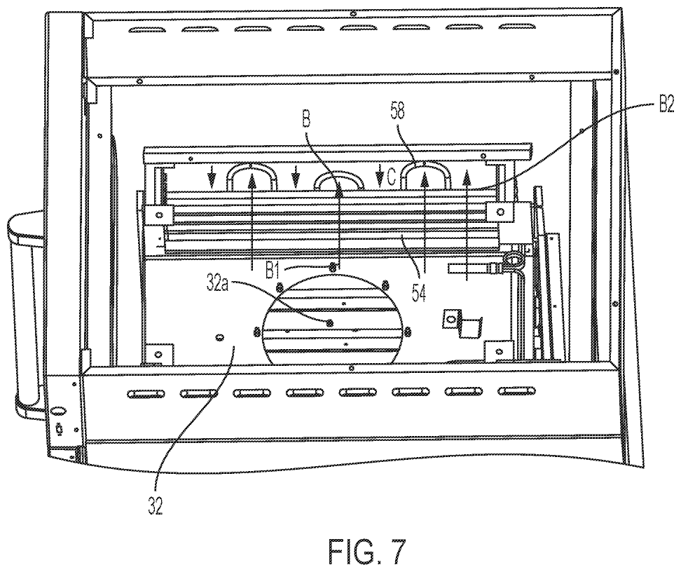

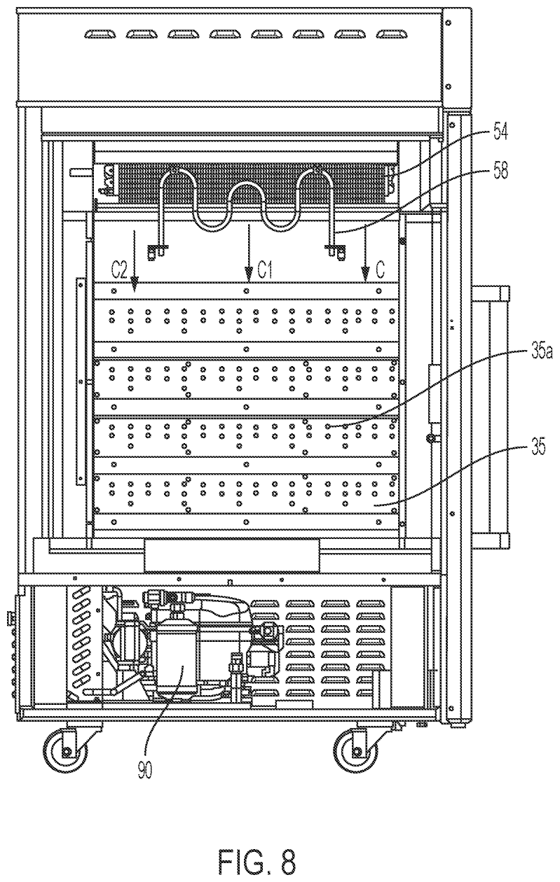

In some embodiments, the heaters 58, 59 may be resistive heaters, such as silicone pad heaters, or heating elements, while in other embodiments, the heaters may be other components such as burners. The heaters may be straight, or curved, planar, or may be serpentine to include multiple legs that are present within flow path C and CC, such that air flows over several legs of the heater when flowing therepast. In the case of pad heaters, the air flows over the surface area of the planar heater. In the embodiments depicted in the figures, the heaters 58, 59 may be curved such as to form a waved geometry (similar to a sine wave), which maximizes the area of the heater that the air flowing through path C and CC passes by without providing multiple legs. In some embodiments the heaters 58, 59 may extend along the entire flow path (front to back of the cabinet) so that all of the air along path C and CC passes by a portion of the heater, while in other embodiments, as shown in FIGS. 7 and 8, the heaters 58, 59 may only extend a portion of the flow path, such that some air flows by the heaters (B1, C1), and other air (B2 and C2) does not flow directly by the heaters. As one of ordinary skill in the art will readily comprehend after a thorough review of this specification and figures, it is routine skill in the art to optimize the size and positioning of the heaters within the cabinet to achieve the desired heat transfer to air flowing in paths B/BB and C/CC.

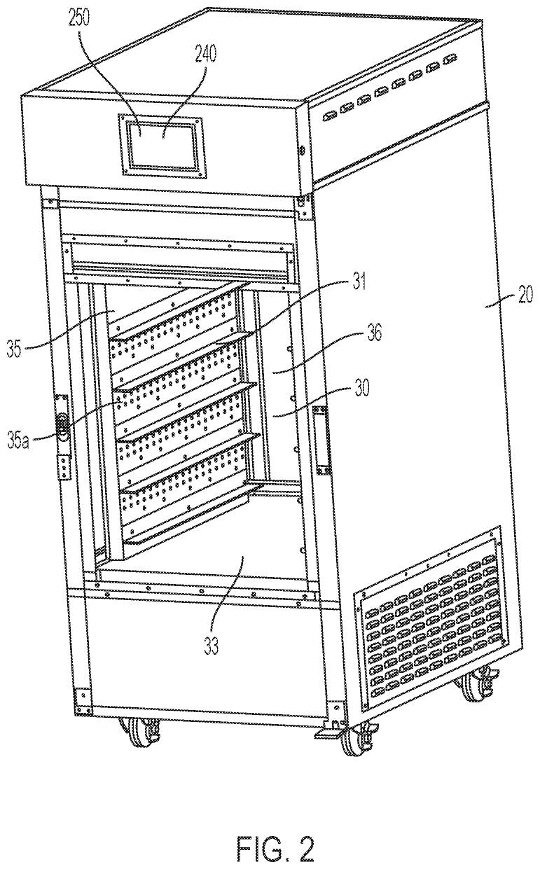

The auxiliary compartment may include respective left and right plenums 42, 41 that lead from the heat transfer compartment 40 to return to the food storage compartment 30, such that air from paths B and BB is received in the respective left and right plenums 42, 41, and air flowing through the plenums is depicted as C and CC. The left and right plenums 42, 41 may be spaced between the respective left and right walls and the outer walls of the housing. In embodiments where insulation is provided between the outer walls and the walls that define the food storage compartment 30, the insulation may be provide outside of the respective plenum (i.e. on an opposite side of the respective plenum from the food storage compartment 30). The left and right plenums 42, 41 may be disposed along the left and right walls and along most of or the entire depth of the food storage compartment 30. The respective left and right side walls 35, 34 may each include a plurality of apertures 35a (FIG. 2) to allow air to flow therethrough from the plenum and into the food storage compartment 30. The apertures 35a may be disposed in a uniform pattern about all or substantially all of the left and right walls 35, 34, while in other embodiments, the apertures 35a may be disposed with a higher concentration, and/or larger size at different portions of the left and right walls 35, 34 in order to balance the flow (in directions D and DD as depicted in FIG. 4) as desired—such as more flow into the food storage compartment 30 near the floor 33 than near the top wall 32.

The system may include a temperature sensor 88 that measures a temperature of the air flowing through the cabinet 10. The temperature sensor 88 may be disposed at a desired location within the cabinet, and the control of the heaters and the refrigeration system 90 is determined or optimized based upon the position of the temperature sensor 88. In one embodiment, the temperature sensor 88 may be disposed proximate to the fan 50, which is representative of the air temperature within the food storage compartment 30 and specifically the temperature after the air within the food storage compartment has interacted with the food disposed therein. In other embodiments, one or more temperature sensors may be provided at other positions, such as downstream of the evaporator tubes 54, 55, or downstream of the heaters 58, 59, which provide an indication of the working air temperature at different positions, such as representative of the air temperature entering the food storage compartment 30.

A controller 200 (shown schematically in FIG. 4) is provided and controls the operation of the blower 50, the refrigeration system 90, and the heaters 58, 59 in order to selectively provide air flow within the cabinet as discussed above, and to regulate the temperature of the air flowing therethrough, as measured by the temperature sensor 88. As discussed above, the cabinet 10 can be operated in two modes, a thawing mode and a refrigeration mode, and in some embodiments, the controller may transition the cabinet from the thawing mode to the refrigeration mode. The controller 200 includes an input 250 and a display 240, which in some embodiments, the input 250 may be part of the display such as a touch screen display. In some embodiments, the input 250 allows the user to provide the controller with information regarding the food product that is placed within the food storage compartment 30, such as the type of food, the state of the food when it is placed within the food storage compartment (e.g. frozen, thawed, what temperature the food is at when placed into the food storage compartment 30, etc.).

The controller 200 is configured to obtain the inputs such as type of food and initial temperature of the food being placed in the food storage compartment, and if the user desires to thaw the food placed within the compartment (based upon the user selecting thawing via an input 250), the controller may suggest a thawing recipe for the user to authorize or implement. For example, based upon the inputted weight, type, and potentially the initial temperature and packaging status (i.e. packed, wrapped, not packaged, bulk, individual pieces, etc.) the controller 200 may suggest a recipe for thawing that has been stored into the controller's memory, such as initial thawing at temperature A for a certain time, then thawing at a lower temperature B for a certain time, then thawing at temperature C for a certain time, and then to the holding temperature. The user may authorize the controller to operate the cabinet 10 in accordance with the suggested recipe, or the user may alter one or more steps of the recipe, such as changing one or more times or one or more temperatures for the various steps.

In some embodiments, the controller 200 may be programmed to include an automated mode where the controller automatically selects a recipe based upon the user inputted information and simply starts the recipe upon the user instructing the recipe to begin, or the controller 200 may inquire whether the user wishes to modify the selected recipe and then control the cabinet based upon the modifications made by the user.

As discussed above, the recipe (whether manually authorized by the user or automatically initiated by the controller 200) may attempt to maintain air temperature (as measured by the temperature sensor 88) around one or more different temperatures for set periods of time. For example, in one recipe, the controller 200 may bring the temperature to a nominal 50 degrees (Fahrenheit) for an hour, then bring the temperature to a nominal 45 degrees for an hour, then to a nominal 40 degrees for an hour, then to a nominal 36 degrees where the controller will hold the temperature at that nominal temperature for steady state while the controller 200 is operating the cabinet according to that recipe. In this embodiment, the controller brings the temperature to a nominal temperature, but uses feedback control to (based upon the temperature measured by the temperature sensor 88) to maintain the temperature around that temperature.

For example, if the controller 200 reaches a step to maintain the temperature to a nominal 50 degrees Fahrenheit) (either the initial step of the recipe or a subsequent step) and the sensed temperature is at 51 degrees or higher (1 degree above the nominal value) the controller 200 initiates operation of the refrigeration system 90, which will send relatively cold refrigerant through the tubes 54, 55 (which are passed by air flowing in paths B and BB, respectively) thereby cooling the air. When the sensed temperature reaches 47 degrees (three degrees below the nominal value) the controller 200 will stop operation of the refrigeration system 90 and also begin operation of the heaters 58, 59, which heats the air (flowing in paths C and CC), which ultimately returns to the food storage compartment 30. In some embodiments, the blower 50 constantly runs when both the refrigeration system 90 is operating and when the heaters are energized or operating.

With the heaters 58, 59 operating, the temperature continues to be monitored and when the temperature sensor sees that the temperature has reached/returned to 51 degrees the heaters 58, 59 are deenergized (discontinue operating) and the refrigeration system 90 again operates. In this embodiment, either the heaters 58, 59 are operating, or the refrigeration system 90 is operating at all times, but both the heaters and the refrigeration system 90 do not operate at the same time. In the embodiment, the heaters 58, 59 turn on and operate when the measured temperature is three degrees Fahrenheit below the nominal value and turn off when the temperature is one degree above the nominal value, and the refrigeration system 90 operates when the temperature is one degree above the nominal value and discontinues operation when the temperature is three degrees below the nominal value.

When the set time at the first nominal value has elapsed, the controller 200 turns on the refrigeration system 90 if not operating at that time and discontinues operation of the heaters 58, 59 (or continues operation of the refrigeration system 90) until the temperature decreases to a temperature that is three degrees Fahrenheit below the next desired nominal temperature of the recipe, and the temperature is cycled around the lower nominal temperature with operation of the heaters and refrigeration system 90 in the same manner as described above. When the time elapses for that nominal value the controller—depending upon the status within the recipe—the controller either operates the refrigeration system 90 to lower the temperature to the next recipe level or to the final holding temperature, which is normally below 40 degrees Fahrenheit. If at the final holding temperature, in some embodiments, the controller discontinues all operation of the heaters 58, 59 and cycles the refrigeration system on and off to maintain the temperature within one degree of the final holding temperature.

One of ordinary skill in the art with a thorough review of this specification will understand that the temperature set points for operation of the heaters 58, 59 and the refrigeration system 90 may be modified based upon maintaining different bands, such as the heaters 58, 59 being turned on (and refrigeration system off if running) when the temperature is 2 degrees lower than the nominal temperature (during an intermediate step of the recipe) and the heaters turned off and the refrigeration turned on when the temperature is 2 degrees above the nominal temperature. In still other embodiments, the heaters (when operating) may turn off at a first value above the nominal temperature of the recipe, with the refrigeration system not turning on until the temperature increases to another temperature above the first value, such as one degree above the first value, and similarly, the refrigeration system may turn off at a third value below the nominal temperature with the heaters not turning on until the temperature reaches a temperature that is lower than the third value.

While the preferred embodiments of the disclosed have been described, it should be understood that the invention is not so limited and modifications may be made without departing from the disclosure. The scope of the disclosure is defined by the appended claims, and all devices that come within the meaning of the claims, either literally or by equivalence, are intended to be embraced therein.

1. An enclosed unit for thawing a food product, comprising:
a housing defining a food storage compartment and an auxiliary compartment, the food storage compartment defined by a plurality of walls including top and bottom walls, right and left walls, and a back wall, the food storage compartment has a front opening, which can be selectively enclosed or opened with at least one door;
the housing encloses a refrigeration system with an evaporator disposed within an auxiliary compartment, the auxiliary compartment further comprising a plurality of heaters;
an air flow path is provided between the food storage compartment and the auxiliary compartment, a fan disposed within a suction aperture within one of the plurality of walls, wherein the fan takes suction from the food storage compartment and exhausts air into the auxiliary compartment where air passes across the evaporator and across one or more of the plurality of heaters, one or more of the plurality of walls includes a plurality of return apertures through which air flows after passing across the evaporator and across one or more of the plurality of heaters;
further comprising a controller and a temperature sensor;
the temperature sensor disposed to measure the temperature of air within the housing, the controller receiving the measured temperature from the temperature sensor and comparing the measured temperature to a desired nominal air temperature established within a recipe;
wherein when the measured air temperature is below the desired air temperature by at least a first predetermined threshold, the controller energizes the plurality of heaters and deenergizes the refrigeration system if it was currently operating, and when the measured temperature is above the desired air temperature by at least a second predetermined threshold the controller energizes the refrigeration system and deenergizes the plurality of heaters if they were currently operating.

2. The enclosed unit for thawing a food product of claim 1, wherein the recipe is established with a plurality of different desired nominal air temperatures that decrease from an initial highest desired air temperature to a final nominal desired air temperature, wherein the recipe maintains each different desired nominal air temperature for a predetermined length of time before moving to the next desired nominal air temperature that is below the previous desired nominal air temperature until reaching the final desired nominal air temperature.

3. The enclosed unit for thawing a food product of claim 2, wherein the final desired nominal air temperature is below 40 degrees Fahrenheit.

4. The enclosed unit for thawing a food product of claim 1, wherein the first predetermined threshold is 3 degrees Fahrenheit and the second predetermined threshold is 1 degree Fahrenheit.

5. The enclosed unit for thawing a food product of claim 1, wherein the evaporator comprises a first plurality of tubes that are disposed horizontally in the air flow path to a left side of the fan and a second plurality of tubes that are disposed horizontally in the air flow path to the right side of the fan, and the plurality of heaters comprises a first heater that is disposed downstream of the first plurality of tubes in the air flow path to the left side of the fan and a second heater that is disposed downstream of the second plurality of tubes in the air flow path to the right side of the fan.

6. The enclosed unit for thawing a food product of claim 5, wherein each of the first and second heaters have a generally sinusoidal shape.

7. The enclosed unit for thawing a food product of claim 6, wherein each of the first and second heaters extend for a length that is less than a length of air flow that leaves the evaporator.

8. The enclosed unit for thawing a food product of claim 1, wherein the temperatures sensor is disposed adjacent to the fan.

9. The enclosed unit for thawing a food product of claim 1, wherein the fan continuously operates during operation of the enclosed unit.

10. The enclosed unit for thawing a food product of claim 1, wherein each of the first and second heaters have a planar shape.
